(19) United States
(12) Patent Application Publication
(10) Pub. No.: US 2025/0263108 A1
(43) Pub. Date: Aug. 21, 2025

(54) STEERING SYSTEM

(71) Applicant: TOYOTA JIDOSHA KABUSHIKI KAISHA, Aichi-ken (JP)

(72) Inventors: Yoshio KUDO, Tokyo (JP); Hidetsugu TOYAMA, Susono-shi (JP)

(21) Appl. No.: 19/056,626

(22) Filed: Feb. 18, 2025

(30) Foreign Application Priority Data
Feb. 20, 2024 (JP) 2024-023519

(51) Int. Cl. B62D 5/00

(52) U.S. Cl. CPC B62D 5/006

(57) ABSTRACT

A steer-by-wire type steering system includes an operation device, a turning device, and a controller. The controller is configured to switch between a normal mode and a virtual mode, and executes, when a control mode is switched from the virtual mode to the normal mode, at least one of specific turning control or specific reaction force control.

### CROSS-REFERENCE TO RELATED APPLICATION

This application claims priority to Japanese Patent Application No. 2024-023519 filed on Feb. 20, 2024. The disclosure of the above-identified application, including the specification, drawings, and claims, is incorporated by reference herein in its entirety.

### BACKGROUND

### 1. Technical Field

The present disclosure relates to a steering system.

### 2. Description of Related Art

Recently, in a steer-by-wire type steering system in which an operation member is mechanically separated from a turning device, a steering system has been developed in which a user can play a game using the operation member, for example, while a battery electric vehicle is charged. For example, Japanese Unexamined Patent Application Publication No. 2022-1925 (JP 2022-1925 A) discloses a vehicle in which an operation target by an operation unit of a steering device can be switched between a vehicle and a virtual moving body on a game. That is, such a steering system is configured to switch between a normal mode in which the vehicle is the operation target and a game mode in which the virtual moving body is the operation target.

### SUMMARY

In the steering system, in the game mode (also referred to as virtual mode), wheels can be set not to turn in response to a motion of the operation member of a steering in order to suppress power consumption or tire wear. However, in this case, when a control mode is switched from the game mode to the normal mode, a situation may occur in which a state of the operation member of the steering (that is, operation angle or target turning angle) does not correspond to a state of the wheels (that is, actual turning angle). In this case, the steering system tries to turn the wheels to cause the actual turning angle of the wheels to match the target turning angle. In this case, there is a possibility that an abnormal sound or vibration is generated due to a sudden increase in a current supplied to the turning device.

The present disclosure provides a steering system capable of suppressing generation of an abnormal sound and vibration when a control mode is switched from a virtual mode to a normal mode.

An aspect of the present disclosure relates to a steer-by-wire type steering system including an operation device, a turning device, and a controller. The operation device includes an operation member for a steering operation by a user and a reaction force providing device configured to provide an operation reaction force to the operation member. The turning device is mechanically separated from the operation device and configured to turn wheels according to a turning current to be supplied. The controller is configured to control the turning device and the reaction force providing device based on an operation signal regarding a motion of the operation member received from the operation device and a turning angle signal regarding an actual turning angle of the wheels received from the turning device. The controller is configured to switch between a normal mode in which the wheels are turned based on the operation signal and the turning angle signal and a virtual mode in which a virtual moving body created as a video is steered based on the operation signal, in which the normal mode and the virtual mode are control modes. The controller is configured to set, in the virtual mode, the turning current to a current value at which the wheels are not turned regardless of the operation signal. The controller is configured to execute at least one of, when the control mode is switched from the virtual mode to the normal mode, specific turning control of controlling the turning device based on the operation signal and the turning angle signal such that the turning device turns the wheels at a speed lower than a speed at which the turning device turns the wheels in the normal mode, in a direction in which the actual turning angle approaches an angle corresponding to the operation signal or specific reaction force control of controlling the reaction force providing device based on the operation signal and the turning angle signal such that an operation angle of the operation member approaches an angle corresponding to the actual turning angle.

In the aspect of the disclosure, the controller may be configured to execute at least one of the specific turning control and the specific reaction force control until a state of the wheels corresponding to the operation signal matches a state of the wheels corresponding to the turning angle signal after the control mode is switched from the virtual mode to the normal mode.

In the aspect of the disclosure, the controller may be configured to, in the normal mode, calculate an angle difference that is a difference between a target turning angle based on the operation signal and the actual turning angle based on the turning angle signal, calculate a current value of the turning current corresponding to the angle difference, and supply the turning current corresponding to the calculated current value to the turning device, and gradually increase, as the specific turning control, the turning current supplied to the turning device until the turning current reaches the current value corresponding to the angle difference.

In the aspect of the disclosure, the controller may be configured to set a gradual increase amount of the turning current based on the operation angle of the operation member, the actual turning angle, or the angle difference.

In the aspect of the disclosure, the controller may be configured to calculate, as the specific reaction force control, the operation angle of the operation member corresponding to the actual turning angle as a target operation angle, and control the reaction force providing device such that the operation angle of the operation member matches the target operation angle.

In the aspect of the disclosure, the controller may be configured to, when the control mode is switched from the virtual mode to the normal mode, selectively execute the specific turning control and the specific reaction force control according to a magnitude of an angle difference that is a difference between a target turning angle based on the operation signal and the actual turning angle based on the turning angle signal.

In the aspect of the disclosure, the controller may be configured to, when the control mode is switched from the virtual mode to the normal mode, execute the specific turning control when the angle difference is larger than zero and equal to or smaller than a predetermined angle, and execute the specific reaction force control when the angle difference is larger than the predetermined angle.

In the aspect of the disclosure, the controller may be configured to, when the control mode is switched from the virtual mode to the normal mode, execute the specific turning control when the angle difference is larger than zero and equal to or smaller than a predetermined angle, and execute the specific turning control and the specific reaction force control at the same time or in a predetermined order when the angle difference is larger than the predetermined angle.

In the aspect of the disclosure, the controller may be configured to execute, when the control mode is switched from the virtual mode to the normal mode, the specific turning control and the specific reaction force control at the same time or in a predetermined order.

In the aspect of the disclosure, the controller may be configured to, when the control mode is switched from the virtual mode to the normal mode, execute the specific reaction force control when the operation angle of the operation member and the actual turning angle of the wheels are rotated to different sides with respect to neutral positions.

In the aspect of the disclosure, the controller may be configured to, when the control mode is switched from the virtual mode to the normal mode, return the operation angle of the operation member to a neutral position by the specific reaction force control and return the actual turning angle of the wheels to a neutral position by the specific turning control when the operation angle of the operation member and the actual turning angle of the wheels are rotated to different sides with respect to the neutral positions.

According to the aspect of the disclosure, when the control mode is switched from the virtual mode to the normal mode, at least one of whether the turning device tries to turn the wheels at a low speed (that is, gradually) as compared with the normal mode or whether the reaction force providing device displaces the state of the operation member to a position corresponding to the state of the wheels by the operation reaction force is executed. Accordingly, the supply of the sudden turning current to the turning device or the sudden change in the turning angle, which may occur when the control mode is switched to the normal mode, is suppressed, and the generation of the abnormal sound and the vibration at the time of the control mode switching is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram of a steering system according to the present embodiment;

FIG. 2 is a conceptual diagram for describing turning control and reaction force control according to the present embodiment;

FIG. 3 is a conceptual diagram for describing specific turning control according to the present embodiment;

FIG. 4 is a conceptual diagram for describing specific reaction force control according to the present embodiment; and

FIG. 5 is a flowchart showing an example of a flow of the control according to the present embodiment.

### DETAILED DESCRIPTION OF EMBODIMENTS

Hereinafter, a steering system 1, which is an embodiment of the present disclosure, will be described in detail with reference to drawings as an embodiment of the present disclosure. The present disclosure can be implemented in various aspects in which various changes and modifications are made based on the knowledge of those skilled in the art in addition to the following examples. The steering system 1 according to the present embodiment is mounted on a battery electric vehicle as an example. Communication in the vehicle is performed by, for example, a car area network or controllable area network (CAN), FlexRay, or Ethernet.

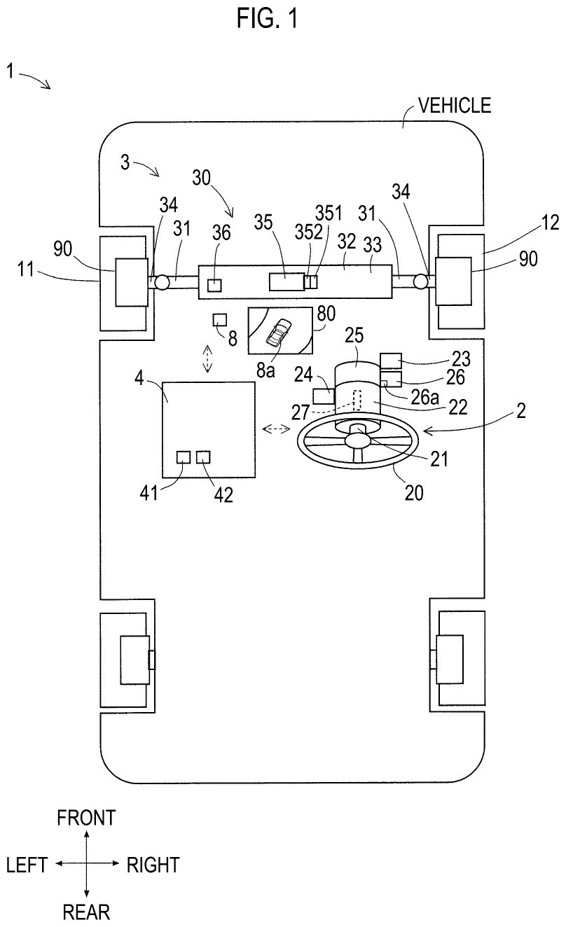

As shown in FIG. 1, the steering system 1 includes an operation device 2, a turning device 3, and a controller 4. The operation device 2 according to the present embodiment includes an operation member 20, a steering shaft 21, a steering column 22, an operation amount sensor 23, an operation torque sensor 24, and a reaction force providing device 25.

The operation member 20 is a steering wheel operation member that performs a steering operation by a user, for example, a steering wheel. A shape of the operation member 20 is not limited to a circular shape such as the steering wheel, and may be, for example, a polygonal shape such as a square shape. The operation member 20 may also be referred to as a steering operation member. The operation member 20 is fixed to a tip end of the steering shaft 21. The operation member 20 and the steering shaft 21 are rotatably held by the steering column 22 in an instrument panel reinforcement.

The operation amount sensor 23 detects an operation amount (operation angle) of the operation member 20. The operation torque sensor 24 detects an operation torque of the operation member 20. The operation torque may also be referred to as an operation force applied by the user to the operation member 20. The operation torque sensor 24 detects, for example, a twisted amount of a torsion bar 27 incorporated in the steering shaft 21.

The reaction force providing device 25 provides an operation reaction force to the operation member 20. The reaction force providing device 25 includes a reaction force motor 26 that is an electric motor. The reaction force providing device 25 provides the operation reaction force in response to the steering operation to the operation member 20, with the reaction force motor 26 supported by the steering column 22 as a force source, via the steering shaft 21. The reaction force providing device 25 has a general structure including a reducer and the like. The reaction force motor 26 is provided with a rotation angle sensor 26a.

The turning device 3 turns wheels 11, 12 (front wheels or turning wheels). The turning device 3 is mechanically separated from the operation device 2. The turning device 3 includes a turning motor 35 that is an electric motor as a drive source, and a current sensor 351 that detects a current value of a turning current input to the turning motor 35. More specifically, the turning device 3 includes a steering rod 31, a housing 32, a rod moving mechanism 33, the turning motor 35, the current sensor 351, a rotation angle sensor 352, and a turning angle sensor 36.

The steering rod 31 is a member in which both ends of the steering rod 31 are respectively connected to right and left steering knuckles 90 via tie rods 34. The housing 32 is a member that supports the steering rod 31 to be movable right and left and is held by a vehicle body in a fixed manner.

The rod moving mechanism 33 causes the steering rod 31 to move right and left with the turning motor 35 as the drive source. The turning motor 35 is an electric motor that turns the wheels 11, 12. The rod moving mechanism 33 is mainly a ball screw mechanism configured of a ball groove that is threadedly provided to the steering rod 31 and a nut that is screwed into the ball groove via a bearing ball and is rotated by the turning motor 35. Since the rod moving mechanism 33 has a general structure, detailed description thereof will be omitted.

The current sensor 351 detects a current value of a control current (that is, turning current) input to the turning motor 35. The rotation angle sensor 352 detects a rotation angle of the turning motor 35. The turning angle sensor 36 detects a turning angle (turning amount) of the wheels 11, 12. The turning angle sensor 36 detects moving amounts of the steering rod 31 to the respective right and left from a neutral position.

The controller 4 is configured to control the turning device 3 and the reaction force providing device 25, based on an operation signal related to a motion of the operation member 20 received from the operation device 2. The controller 4 is configured to receive, from the turning device 3, a turning angle signal related to the turning angle of the wheels 11, 12, that is, a detection value of the turning angle sensor 36. The controller 4 may be referred to control the turning device 3 and the reaction force providing device 25, based on the operation signal and the turning angle signal.

The controller 4 is a computer including one or more processors 41 and one or more memories 42. The computer may also be referred to as an electronic control unit (ECU). The controller 4 is communicably connected to the operation device 2 and the turning device 3. The operation device 2 and the turning device 3 are electrically connected via the controller 4. That is, the steering system 1 is a steer-by-wire type steering system in which a mechanical motion of the operation member 20 by the user is converted into an electric signal and the electric signal is transmitted to the turning device 3 that is mechanically separated from the operation member 20 to steer the vehicle. The controller 4 may be configured by two or more computers connected to be communicable with each other. For example, the controller 4 may be configured by a controller (computer) of the operation device 2 and a controller (computer) of the turning device 3.

### Control Mode

The steering system 1 is configured to switch between a normal mode in which the wheels 11, 12 are turned based on the operation signal and a virtual mode in which a virtual moving body 8a created as a video is steered based on the operation signal. That is, at least two control modes are set in the steering system 1. The normal mode is a control mode in which the vehicle is steered based on the motion of the operation member 20. The virtual mode is, for example, a control mode in which the virtual moving body 8a (for example, vehicle video) expressed as the video on the game is operated by the operation member 20. The virtual moving body 8a is created as a video that can be viewed in the vehicle. The normal mode may also be referred to as, for example, a first mode, a main mode, or a real mode. The virtual mode may also be referred to as, for example, a second mode, a sub-mode, or a game mode.

A display device 80 is disposed in the vehicle. Examples of the display device 80 include a display of an instrument panel, a display of a navigation system, a front windshield on which an image or the like is projected, a display of a portable terminal, AR glasses, and a head-mounted display. The game machine 8 may be disposed in the vehicle, or may be disposed outside the vehicle by being connected to the vehicle by wireless communication. The game machine 8 may be referred to as a computer including one or more processors and one or more memories. The game machine 8 and the controller 4 (and/or CAN) are connected such that solely predetermined information can be communicated.

In the virtual mode, the game machine 8 displays the virtual moving body 8a on the display device 80. The controller 4 and/or the CAN transmit the operation signal or the like (for example, operation information that can be read from the operation signal) to the game machine 8. The game machine 8 creates a display image of the virtual moving body 8a on the display device 80, based on the information received from the vehicle side (for example, CAN), and displays a situation in which the virtual moving body 8a is steered on the display device 80. That is, in the virtual mode, with the operation of the operation member 20, the user can steer the virtual moving body 8a displayed on the display device 80.

The controller 4 switches between the normal mode and the virtual mode based on the operation (instruction) of the user. For example, when the user performs a button operation of selecting the virtual mode on mode selection means (for example, operation panel) provided in the vehicle, the controller 4 checks that a predetermined switching condition is satisfied, and then switches the control mode of the vehicle from the normal mode to the virtual mode. Similarly, the controller 4 switches the control mode from the virtual mode to the normal mode, based on the operation of the user on an operation panel or the like. When the user selects the virtual mode and the predetermined switching condition is satisfied, the controller 4 turns on a change permission flag. When the user does not select the virtual mode or when the predetermined switching condition is not satisfied, the change permission flag is maintained to be turned off. The virtual mode is a control mode in which the user is assumed to play the game using the operation member 20 when the battery electric vehicle is in a stopped state, for example, while a battery of the battery electric vehicle is charged.

### Details of Normal Mode

In the normal mode, the controller 4 controls the turning motor 35 based on the detection value of the operation amount sensor 23 (operation amount or operation angle of the operation member 20). The controller 4 calculates a target turning angle from the detection value of the operation amount sensor 23, and sets the current value of the turning current based on an angle difference that is a difference between the target turning angle and an actual turning angle (detection value of the turning angle sensor 36). The controller 4 supplies the set turning current to the turning motor 35.

In the normal mode, the controller 4 sets the operation reaction force to the operation member 20, based on the detection values of the operation amount sensor 23 and the operation torque sensor 24, to control the reaction force motor 26. The controller 4 supplies a control current (hereinafter also referred to as “reaction force current”) according to the set operation reaction force to the reaction force motor 26. In the normal mode, the controller 4 sets the operation reaction force of the operation member 20, for example, to simulate a power steering type steering system (hereinafter also referred to as “mechanical connection type system”) in which the operation member 20 is mechanically connected to the turning device 3.

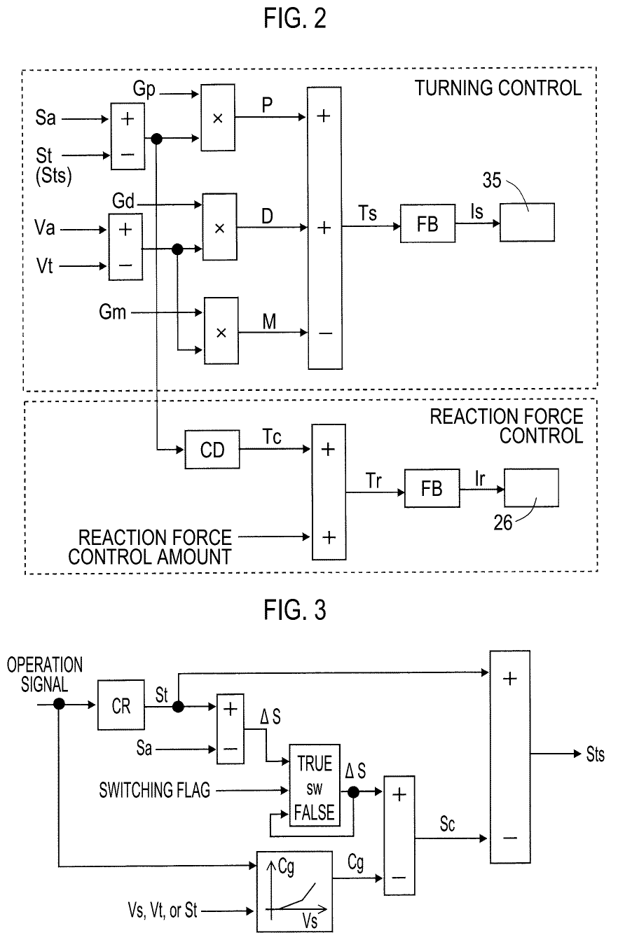

As an example of the calculation by the controller 4, as shown in FIG. 2, in turning control, a deviation term P is calculated by multiplying an angle difference that is a difference between a target turning angle St and an actual turning angle Sa by a predetermined deviation term gain Gp. Further, a speed term D is calculated by multiplying a speed difference that is a difference between a target turning angular velocity Vt, which is a value obtained by performing time differentiation on the target turning angle St, and an actual turning angular velocity Va, which is a value obtained by performing time differentiation on the actual turning angle Sa, by a predetermined speed term gain Gd. Further, the speed difference is multiplied by a damping term gain Gm to calculate a damping term M.

The damping term M is subtracted from a sum of the deviation term P and the speed term D, and a turning torque command value Ts is calculated. The deviation term P is a calculation term that increases a turning torque as the angle difference is larger. The speed term D is a calculation term that increases the turning torque as the speed difference is larger. The damping term M is a calculation term that suppresses a sudden change in the turning torque. The turning torque command value Ts is converted into a turning current command value by current feedback control, and a turning current Is corresponding to the turning current command value is supplied to the turning motor 35.

In the above calculation, another calculation term (for example, integral term) used in known feedback control may be used as the calculation term. The speed term D may also be referred to as a differential term. The deviation term P is an example of a first term, the speed term D is an example of a second term, and the damping term M is an example of a third term. The deviation term gain Gp is an example of a first gain, the speed term gain Gd is an example of a second gain, and the damping term gain Gm is an example of a third gain.

In reaction force control, a compensation torque value Tc set based on the angle difference is added to a reaction force control amount set based on the detection value of the operation amount sensor 23 to calculate a reaction force torque command value Tr. The compensation torque value Tc is set to be larger as the angle difference is larger. Control of setting the compensation torque value Tc is referred to as deviation compensation control CD. The compensation torque value Tc is set to inform the user of a magnitude of the angle difference, that is, follow-up shortage of the turning motor 35 to the target turning angle. The compensation torque value Tc is set from viewpoints of information provision to the user and operation suppression. The reaction force control amount will be described below. The reaction force torque command value Tr is converted into a reaction force current command value by current feedback control FB, and a reaction force current Ir corresponding to the reaction force current command value is supplied to the reaction force motor 26.

As an example of calculation of the reaction force control amount, the reaction force control amount is a value including a virtual axial force value Fv, which is separately calculated. The virtual axial force value Fv is calculated based on, for example, a current axial force value Fi and an angle axial force value Fa. The current axial force value Fi is the operation reaction force set based on a change in the turning current. For example, when the vehicle travels on an uneven road surface, or the like, the angle difference is generated due to a change in the actual turning angle Sa, and thus the change in the turning current may appear. This is because a turning load changes according to a road surface situation. The current axial force value Fi is set (calculated) according to such a change in the turning current to inform the user of the road surface situation. With the change in the operation reaction force according to the change in the turning current, the user can understand the road surface situation. The current axial force value Fi may be referred to as a component of the feedback control, and the angle axial force value Fa may be referred to as a component of feedforward control.

### Details of Virtual Mode

In the virtual mode, the controller 4 sets the turning current to a current value at which the wheels 11, 12 do not turn, regardless of the operation signal (regardless of the motion of the operation member 20). The controller 4 may also be referred to set an absolute value of the turning current to be equal to or less than a predetermined value. As an example, in the virtual mode, the controller 4 sets the turning current to zero regardless of the operation signal. That is, the controller 4 is configured to not supply the turning current to the turning motor 35 in principle, in the virtual mode. Accordingly, the turning motor 35 is not operated and the wheels 11, 12 are not turned by the operation signal. The current value (hereinafter also referred to as “predetermined current value”) of the turning current at which the wheels 11, 12 do not turn can be calculated in advance by an experiment or a simulation, for example, assuming that the vehicle travels on a general paved road or an unpaved road.

An example of processing of setting the turning current to the predetermined current value will be described assuming that the predetermined current value is set to zero. In the virtual mode, the controller 4 sets the turning torque command value Ts to zero, regardless of values of the deviation term P, the speed term D, and the damping term M. Accordingly, the turning current command value is also set to zero, and the turning current Is is also set to zero (refer to FIG. 2). As another example, in the virtual mode, the controller 4 may set each value of the deviation term P, the speed term D, and the damping term M to zero. Further, as another example, in the virtual mode, the controller 4 may set each value of the deviation term gain Gp, the speed term gain Gd, and the damping term gain Gm to zero. Further, as another example, in the virtual mode, the controller 4 may set the turning current command value to zero. With the pieces of processing, the turning current Is can also be set to zero. When the predetermined value is a value other than zero, from the viewpoint of easy calculation, the controller 4 may set the turning torque command value Ts or the turning current command value to a value corresponding to the predetermined current value.

Further, as another example, in the virtual mode, the controller 4 may set the target turning angle to a predetermined angle (constant value), regardless of the operation signal (operation amount or operation angle of the operation member 20). According to the above, there is a state where each of the calculation terms P, D, M is not output and the turning torque command value Ts is also not output. That is, in the above configuration, the turning current Is can be also set to zero. When the target turning angular velocity is not calculated based on the target turning angle, in the virtual mode, the controller 4 sets the target turning angle to the predetermined angle and sets the target turning angular velocity to zero.

When the control mode is switched from the normal mode to the virtual mode and the turning torque command value Ts is set to zero, the controller 4 may gradually decrease the turning torque command value Ts from a value at the time of switching toward zero. That is, the controller 4 may gradually decrease the turning torque command value Ts from the value in the normal mode immediately before the control mode switching toward zero. As means for the gradual decrease, for example, a rate limit, that is, a temporal gradient constraint may be used, or filter processing that delays a signal phase may be used.

In the reaction force control in the virtual mode, the controller 4 sets the compensation torque value Tc to a predetermined torque value regardless of the angle difference. Accordingly, it is possible to control the compensation torque value Tc, which is a component unsuitable for the virtual mode, to an appropriate value. As an example, the predetermined torque value in the present embodiment is zero. That is, in the virtual mode, the controller 4 sets the compensation torque value Tc to zero regardless of the angle difference.

Switching from Virtual Mode to Normal Mode

When the control mode is switched from the virtual mode to the normal mode, the controller 4 is configured to execute at least one of the specific turning control or the specific reaction force control. The controller 4 executes at least one of the specific turning control or the specific reaction force control until a predetermined condition is satisfied after the control mode is switched from the virtual mode to the normal mode.

The predetermined condition includes, for example, “a state of the wheels 11, 12 corresponding to the operation signal matches a state of the wheels 11, 12 corresponding to the turning angle signal”. That is, the controller 4 executes at least one of the specific turning control or the specific reaction force control until the state (target turning angle) of the wheels 11, 12 corresponding to the operation signal matches the state (actual turning angle) of the wheels 11, 12 corresponding to the turning angle signal after the control mode is switched from the virtual mode to the normal mode. The predetermined condition may include, in addition to or instead of the above condition, “supply of the turning current corresponding to the operation signal to the turning device 3” and/or “elapse of a predetermined time after the switching”. As described above, the controller 4 executes at least one of the specific turning control or the specific reaction force control for a specific period after the control mode is switched from the virtual mode to the normal mode.

In the specific turning control, the turning device 3 is controlled, based on the operation signal and the turning angle signal, such that the turning device 3 turns, in a direction in which the actual turning angle approaches an angle corresponding to the operation signal, the wheels 11, 12 at a speed lower than a speed at which the turning device 3 turns the wheels 11, 12 in the normal mode. In the specific reaction force control, the reaction force providing device 25 is controlled, based on the operation signal and the turning angle signal related to the actual turning angle of the wheels 11, 12 received from the turning device 3, such that the operation angle of the operation member 20 approaches an angle corresponding to the actual turning angle of the wheels 11, 12.

### Example of Specific Turning Control

A case will be described in which the controller 4 is configured to execute the specific turning control when the control mode is switched to the normal mode. When the control mode is switched to the normal mode, the specific turning control is executed when the target turning angle of the wheels 11, 12 corresponding to the operation angle of the operation member 20 is different from the actual turning angle of the wheels 11, 12, that is, when there is the angle difference. In the specific turning control, the turning device 3 gradually turns the wheels 11, 12 in turning the wheels 11, 12 such that the actual turning angle of the wheels 11, 12 matches the target turning angle. In other words, when the control mode is switched, the controller 4 gradually increases the turning current, instead of suddenly increasing the turning current to the current value corresponding to the angle difference. Accordingly, when the control mode is returned to the normal mode, the turning device 3 tries to turn the wheels 11, 12 relatively slowly at a speed lower than a turning speed (hereinafter also referred to as “normal turning speed”) of the wheels 11, 12 when the angle difference is generated in the normal mode of the vehicle in a stopped state. The controller 4 controls the turning device 3 such that the turning device 3 turns the wheels 11, 12 at the speed lower than the normal turning speed (gradually) according to the angle difference.

As an example, in the specific turning control, the controller 4 uses a temporary target turning angle Sts instead of the target turning angle St in the turning control calculation of FIG. 2. As shown in FIG. 3, the temporary target turning angle Sts is calculated based on the target turning angle St and an angle difference ΔS. The target turning angle St is calculated based on the operation signal (operation angle of the operation member 20) and a set gear ratio (variable gear ratio). The controller 4 calculates the target turning angle St from the operation signal (operation angle) by variable gear ratio calculation CR. The controller 4 calculates the angle difference ΔS that is a difference between the target turning angle St and the actual turning angle Sa. When the control mode is switched from the virtual mode to the normal mode, a switching flag is changed from off to on. When the switching flag is turned on, the controller 4 subtracts an adjustment value Sc from the target turning angle St to calculate the temporary target turning angle Sts (Sts=St−Sc).

The adjustment value Sc is a value obtained by subtracting a gradual change amount Cg from the angle difference ΔS (Sc=ΔS−Cg). The gradual change amount Cg is set, for example, to increase for each predetermined time. The gradual change amount Cg is set based on, for example, the operation signal, an operation speed (change speed of the operation angle) Vs of the operation member 20, the target turning angular velocity Vt, and/or the target turning angle St. For example, an increase rate of the gradual change amount Cg is set to be larger as an input element (for example, operation speed Vs) is larger. Accordingly, it is possible to set the gradual change amount Cg suitable for a situation. The gradual change amount Cg may be set based on the detection values of various sensors that represent an operation intention of the user or a state of the vehicle. For example, the controller 4 increases the gradual change amount Cg at a predetermined time interval until the gradual change amount Cg reaches a maximum value (angle difference ΔS). For example, the gradual change amount Cg may be set to increase at a speed (increase amount/time) set in advance. Further, for example, the increase rate of the gradual change amount Cg may be set based on the operation speed immediately before the switching flag is turned on.

An initial value of the gradual change amount Cg is set to zero. Therefore, when the switching flag is turned on (immediately after the switching), the adjustment value Sc has the same value as the angle difference ΔS, and the temporary target turning angle Sts is a value obtained by subtracting the angle difference ΔS from the target turning angle St (initial value: Sts=St−ΔS). In the controller 4, the calculated temporary target turning angle Sts is input instead of the target turning angle St of FIG. 2. As a result, immediately after the control mode is switched to the normal mode, the temporary target turning angle Sts has the same value as the actual turning angle Sa, and a difference between the temporary target turning angle Sts and the actual turning angle Sa is zero. Accordingly, the turning current Is immediately after the control mode switching is zero or a small value.

After the switching flag is turned on, the gradual change amount Cg gradually increases with the elapse of time, and the adjustment value Sc decreases. Accordingly, the temporary target turning angle Sts gradually increases toward the target turning angle St, and the turning current Is also gradually increases. When the gradual change amount Cg increases to the same value as the angle difference ΔS and the adjustment value Sc is zero, the temporary target turning angle Sts matches the target turning angle St. The controller 4 gradually increases the turning current Is by the above logic until the temporary target turning angle Sts matches the target turning angle St after the switching flag is received. Accordingly, the sudden change in the turning current Is after the control mode is switched to the normal mode is suppressed, and generation of abnormal sound and vibration due to the sudden operation of the turning motor 35 is suppressed.

When the switching flag is turned on, the controller 4 executes the specific turning control and may notify the user that “positions of the wheels 11, 12 are being adjusted” by display means or voice means. Further, when the temporary target turning angle Sts matches the target turning angle St, the controller 4 ends the specific turning control. The temporary target turning angle Sts may also be referred to as a specific target turning angle.

The above processing is an example of calculation processing of the specific turning control, and the controller 4 may execute, as the specific turning control, processing of gradually increasing the turning current Is toward the turning current Is corresponding to the angle difference ΔS. In other words, when the control mode is switched from the virtual mode to the normal mode and the turning torque command value Ts is returned to an original value (value in the normal mode) from zero, the controller 4 may gradually increase the turning torque command value Ts from zero. That is, the controller 4 may gradually (stepwise) increase the turning torque command value Ts from zero to the original value. In addition to the above, as means for the gradual increase, for example, a rate limit, that is, a temporal gradient constraint may be used, or filter processing that delays a signal phase may be used.

It is possible to describe a summary of the example of the specific turning control as follows. In the normal mode, the controller 4 is configured to calculate the angle difference ΔS that is the difference between the target turning angle St based on the operation signal and the actual turning angle Sa based on the turning angle signal, calculate the current value of the turning current Is corresponding to the angle difference ΔS, and supply the turning current Is corresponding to the calculated current value to the turning device 3. The controller 4 gradually increases, as the specific turning control, the turning current Is supplied to the turning device 3 until the turning current Is reaches the current value corresponding to the angle difference ΔS. A gradual increase amount (for example, increase amount per unit time) may be set based on the intention of the user or the state of the vehicle, for example, the operation angle, the actual turning angle, or the angle difference of the operation member 20. That is, for example, an operation angular velocity at the time of (for example, immediately before or immediately after) the control mode switching based on the operation angle may be calculated, and the gradual increase amount may be set based on the operation angular velocity.

### Example of Specific Reaction Force Control

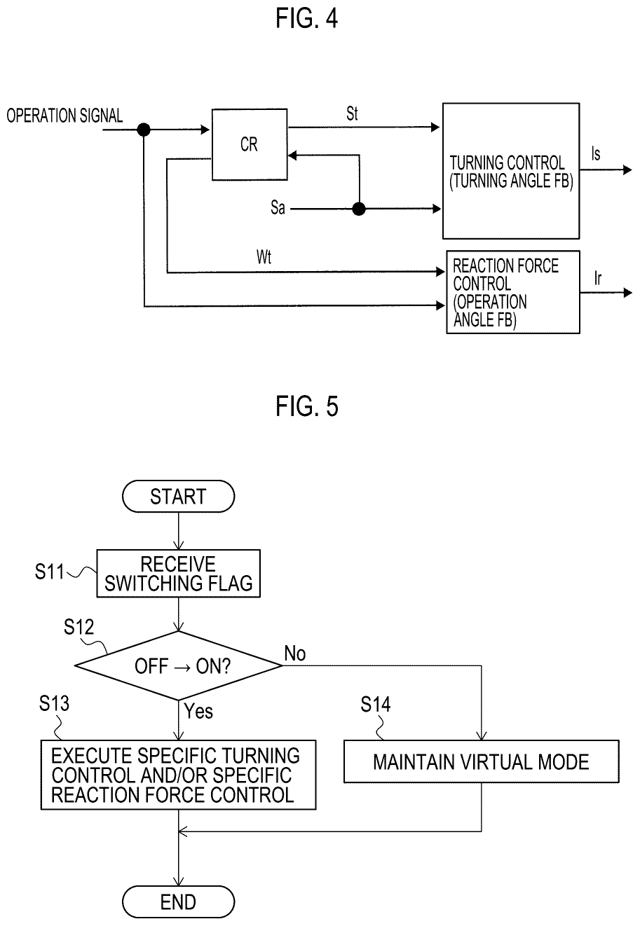

A case will be described in which the controller 4 is configured to execute the specific reaction force control when the control mode is switched to the normal mode. In the specific reaction force control, the controller 4 calculates the operation angle of the operation member 20 corresponding to the actual turning angle Sa as a target operation angle Wt, as shown in FIG. 4. The controller 4 calculates the target operation angle Wt from the actual turning angle Sa by inverse calculation of the variable gear ratio calculation CR. When the switching flag is turned on, the controller 4 operates, by the specific reaction force control, the operation member 20 with the operation reaction force to rotate the operation member 20 to the angle (target operation angle Wt) corresponding to the actual turning angle Sa when the actual turning angle Sa does not correspond to the operation angle of the operation member 20, that is, when there is the angle difference ΔS. The reaction force current Ir (operation reaction force) is set to a value at which the operation member 20 is displaced to the target operation angle Wt. With the specific reaction force control, when the switching flag is turned on, the operation member 20 returns to a position corresponding to the actual turning angle Sa by a drive force of the reaction force motor 26. Accordingly, the generation of the abnormal sound and the vibration of the turning motor 35 due to a sudden wheel turning command to the turning device 3 is suppressed.

As described above, the controller 4 calculates, as the specific reaction force control, the operation angle of the operation member 20 corresponding to the actual turning angle as the target operation angle Wt to control the reaction force providing device 25 such that the operation angle of the operation member 20 matches the target operation angle Wt. When the switching flag is turned on, the controller 4 executes the specific reaction force control and may notify the user that “position of the operation member 20 is being adjusted” by display means or voice means. Further, the controller 4 may also gradually increase the reaction force current Ir (operation reaction force) toward a value corresponding to the target operation angle Wt. The drive force of the reaction force motor 26 is small as compared with the drive force of the turning motor 35, and the possibility of the generation of the abnormal sound or vibration due to a sudden increase in the reaction force current Ir is small.

As shown in FIG. 5, the controller 4 receives the switching flag in the virtual mode (S11), and determines whether or not the switching flag is changed from off to on (S12). For example, when a state flag indicating a virtual mode state received last time is on and the state flag indicating the virtual mode state received this time is off, the switching flag is changed from off to on. When the switching flag is changed from off to on (Yes in S12), the controller 4 executes at least one of the specific turning control or the specific reaction force control (S13). When the switching flag is maintained to be turned off in the virtual mode (No in S12), the virtual mode is maintained (S14).

According to the present embodiment, when the control mode is switched from the virtual mode to the normal mode, at least one of whether the turning device 3 tries to turn the wheels 11, 12 at a low speed (that is, gradually) as compared with the normal mode or whether the reaction force providing device 25 displaces the state of the operation member 20 to a position corresponding to the state of the wheels 11, 12 by the operation reaction force is executed. Accordingly, the supply of the sudden turning current to the turning device 3 or the sudden change in the turning angle, which may occur when the control mode is switched to the normal mode, is suppressed, and the generation of the abnormal sound and the vibration at the time of the control mode switching is suppressed.

### Other Control Examples

The controller 4 may execute the specific turning control and the specific reaction force control at the same time or in a predetermined order. For example, the controller 4 may control the reaction force providing device 25 such that the operation member 20 is operated by the specific reaction force control to reduce the angle difference ΔS by a predetermined amount, and then execute the specific turning control for the reduced angle difference ΔS. That is, the specific turning control is executed based on the updated angle difference ΔS. On the contrary, the controller 4 may execute the specific turning control first and then execute the specific reaction force control. In this case, the specific reaction force control is executed based on an updated actual turning angle. Further, the controller 4 may execute the specific reaction force control while the specific turning control is executed. In this case, with the execution of each control, the operation angle or the actual turning angle is sequentially updated such that the angle difference ΔS is zero. An execution order of the pieces of control may be set from the viewpoint of improving safety and reducing the sense of discomfort of the user. Further, in the steering system 1, when the vehicle driving by the user is set to be prohibited during the execution of the specific turning control or the specific reaction force control, the order of both pieces of control may be set also from the viewpoint of shortening a transition time to a drivable state.

Further, for example, when the operation angle of the operation member 20 is shifted from a neutral position (vehicle straight advancing position) in one rotation direction side and the actual turning angle of the wheels 11, 12 is shifted from a neutral position in the other rotation direction side, the controller 4 may execute solely the specific reaction force control out of the specific turning control and the specific reaction force control. In such a case, from the viewpoint of improving safety and reducing the sense of discomfort of the user, it is considered better to operate the operation member 20 rather than to turn the wheels 11, 12. The above situation is a situation where the operation member 20 is at a position being rotated counterclockwise (leftward) from the neutral position and the wheels 11, 12 are at a position being turned on a right side (rightward) from the neutral position, or a situation where the operation member 20 is at a position being rotated clockwise (rightward) from the neutral position and the wheels 11, 12 are at a position being turned on a left side (leftward) from the neutral position.

Further, in the same situation, that is, when the operation angle of the operation member 20 and the actual turning angle of the wheels 11, 12 are rotated to different sides (directions) with respect to the neutral positions (respective neutral positions), the operation angle of the operation member 20 may be returned to the neutral position by the specific reaction force control, and the actual turning angle of the wheels 11, 12 may be returned to the neutral position by the specific turning control. In other words, in this case, the controller 4 executes the specific reaction force control until the operation angle of the operation member 20 returns to the neutral position, and executes the specific turning control until the actual turning angle of the wheels 11, 12 returns to the neutral position. Accordingly, after the control mode is switched to the normal mode, the operation member 20 and the wheels 11, 12 are respectively adjusted to the neutral positions. In the control, the specific reaction force control and the specific turning control may be executed at the same time or may be executed in the predetermined order.

Further, when the control mode is switched to the normal mode, the controller 4 may execute the specific turning control when the operation member 20 is in the neutral position and there is the angle difference ΔS. Further, when the control mode is switched to the normal mode, the controller 4 may execute the specific reaction force control when the wheels 11, 12 are in the neutral position and there is the angle difference ΔS. With the above, after the control mode is switched to the normal mode, the operation member 20 and the wheels 11, 12 are respectively in the neutral positions.

Further, when the control mode is switched from the virtual mode to the normal mode, the controller 4 may selectively execute the specific turning control and the specific reaction force control according to a magnitude of the angle difference. In other words, the controller 4 may execute the “specific turning control”, the “specific reaction force control”, or “both the specific turning control and the specific reaction force control (at the same time or sequentially)” according to the magnitude of the angle difference ΔS at a point in time at which the switching flag is turned on. Accordingly, it is possible to execute the control that is more suited to a situation.

For example, when the control mode is switched to the normal mode, the controller 4 may be configured to execute the specific turning control when the angle difference ΔS is larger than zero and equal to or smaller than a predetermined angle (0<ΔS≤predetermined angle), and to execute the specific reaction force control when the angle difference ΔS is larger than the predetermined angle (ΔS>predetermined angle). As one idea, when the angle difference ΔS is small, it is possible to relatively quickly perform the transition to the drivable state with the gradual change in the actual turning angle of the wheels 11, 12 by the specific turning control. Further, when the angle difference ΔS is large, it may be considered to be more effective, from the viewpoint of improving safety and reducing the sense of discomfort of the user, to change the state of the operation member 20 by the specific reaction force control rather than to turn the wheels 11, 12. Based on such an idea, the control to be executed may be different according to the magnitude of the angle difference ΔS as described above.

Further, when the control mode is switched to the normal mode, the controller 4 may be configured to execute the specific turning control when the angle difference ΔS is larger than zero and equal to or smaller than the predetermined angle (0<ΔS≤predetermined angle), and to execute the specific turning control and the specific reaction force control at the same time or in the predetermined order when the angle difference ΔS is larger than the predetermined angle (ΔS>predetermined angle). For example, with the execution of the specific reaction force control with a relatively small displacement amount (angle change amount) and the execution of the specific turning control with a relatively large displacement amount, it is possible to shorten the transition time to the drivable state.

The game machine 8 may function as, for example, a simulator for driving training. Further, it is possible to apply the technique of the present disclosure to a moving body other than the battery electric vehicle. Further, it is possible to combine various types of control or processing of the present disclosure as appropriate.

What is claimed is:

1. A steer-by-wire steering system comprising:
an operation device including an operation member for a steering operation by a user and a reaction force providing device configured to provide an operation reaction force to the operation member;
a turning device mechanically separated from the operation device and configured to turn wheels according to a turning current to be supplied; and
a controller configured to control the turning device and the reaction force providing device based on an operation signal regarding a motion of the operation member received from the operation device and a turning angle signal regarding an actual turning angle of the wheels received from the turning device, the controller being configured to switch between a normal mode in which the wheels are turned based on the operation signal and the turning angle signal and a virtual mode in which a virtual moving body created as a video is steered based on the operation signal, in which the normal mode and the virtual mode are control modes,
wherein the controller is configured to
set, in the virtual mode, the turning current to a current value at which the wheels are not turned regardless of the operation signal, and
execute at least one of, when the control mode is switched from the virtual mode to the normal mode,
specific turning control of controlling the turning device based on the operation signal and the turning angle signal such that the turning device turns the wheels at a speed lower than a speed at which the turning device turns the wheels in the normal mode, in a direction in which the actual turning angle approaches an angle corresponding to the operation signal or
specific reaction force control of controlling the reaction force providing device based on the operation signal and the turning angle signal such that an operation angle of the operation member approaches an angle corresponding to the actual turning angle.

2. The steering system according to claim 1, wherein the controller is configured to execute at least one of the specific turning control and the specific reaction force control until a state of the wheels corresponding to the operation signal matches a state of the wheels corresponding to the turning angle signal after the control mode is switched from the virtual mode to the normal mode.

3. The steering system according to claim 1, wherein the controller is configured to, in the normal mode,
calculate an angle difference that is a difference between a target turning angle based on the operation signal and the actual turning angle based on the turning angle signal,
calculate a current value of the turning current corresponding to the angle difference, and
supply the turning current corresponding to the calculated current value to the turning device, and
gradually increase, as the specific turning control, the turning current supplied to the turning device until the turning current reaches the current value corresponding to the angle difference.

4. The steering system according to claim 3, wherein the controller is configured to set a gradual increase amount of the turning current based on the operation angle of the operation member, the actual turning angle, or the angle difference.

5. The steering system according to claim 1, wherein the controller is configured to
calculate, as the specific reaction force control, the operation angle of the operation member corresponding to the actual turning angle as a target operation angle, and
control the reaction force providing device such that the operation angle of the operation member matches the target operation angle.

6. The steering system according to claim 1, wherein the controller is configured to, when the control mode is switched from the virtual mode to the normal mode, selectively execute the specific turning control and the specific reaction force control according to a magnitude of an angle difference that is a difference between a target turning angle based on the operation signal and the actual turning angle based on the turning angle signal.

7. The steering system according to claim 6, wherein the controller is configured to, when the control mode is switched from the virtual mode to the normal mode,
execute the specific turning control when the angle difference is larger than zero and equal to or smaller than a predetermined angle, and
execute the specific reaction force control when the angle difference is larger than the predetermined angle.

8. The steering system according to claim 6, wherein the controller is configured to, when the control mode is switched from the virtual mode to the normal mode,
execute the specific turning control when the angle difference is larger than zero and equal to or smaller than a predetermined angle, and
execute the specific turning control and the specific reaction force control at the same time or in a predetermined order when the angle difference is larger than the predetermined angle.

9. The steering system according to claim 1, wherein the controller is configured to execute, when the control mode is switched from the virtual mode to the normal mode, the specific turning control and the specific reaction force control at the same time or in a predetermined order.

10. The steering system according to claim 1, wherein the controller is configured to, when the control mode is switched from the virtual mode to the normal mode, execute the specific reaction force control when the operation angle of the operation member and the actual turning angle of the wheels are rotated to different sides with respect to neutral positions.

11. The steering system according to claim 1, wherein the controller is configured to, when the control mode is switched from the virtual mode to the normal mode, return the operation angle of the operation member to a neutral position by the specific reaction force control and return the actual turning angle of the wheels to a neutral position by the specific turning control when the operation angle of the operation member and the actual turning angle of the wheels are rotated to different sides with respect to the neutral positions.
